(19) United States
(12) Patent Application Publication
(10) Pub. No.: US 2022/0210342 A1
(43) Pub. Date: Jun. 30, 2022

(54) REAL-TIME VIDEO PRODUCTION COLLABORATION PLATFORM

(71) Applicant: Scott M Stickane, Keller, TX (US)

(72) Inventor: Scott M Stickane, Keller, TX (US)

(21) Appl. No.: 17/560,991

(22) Filed: Dec. 23, 2021

Related U.S. Application Data
(60) Provisional application No. 63/132,917, filed on Dec. 31, 2020.

(51) Int. Cl. H04N 5/262; G06F 3/0482

(52) U.S. Cl. CPC H04N 5/262; H04L 65/40; G06F 3/0482

(57) ABSTRACT

A real-time video production collaboration platform which is configured to access a storyboard image associated with a file, receive live video data from a first location, and present, at a second location, the storyboard image in juxtaposition with the received video data. The platform is further configured to receive live feedback from a user at the second location and store that feedback for later use.

### CROSS-REFERENCE TO RELATED APPLICATIONS

This application claims priority to U.S. Provisional Patent Application No. 63/132,917, filed on Nov. 5, 2007. The subject matter of this earlier application is hereby incorporated by reference.

### BACKGROUND

A storyboard is a visual representation of a narrative often used in the entertainment industry to plan video and film projects. By breaking up a narrative into visual elements on a storyboard, components of a story can be refined and revised individually. Storyboarding before filming is also useful for script writing and cinematic direction, including planning aspects of production including scenes, shots, camera angles, lighting, effects, movement, transitions, etc.

A typical storyboard for a video commercial includes a series of thumbnail images in a sequence. Each thumbnail represents a shot in a scene and includes information such as annotations or notes about shots and scenes (e.g., movement/action of actors, props, or environment), sounds (e.g., voice over, dialogue, music, etc.), and camera directions (e.g., focal points, zoom, movement, etc.).

Often, storyboards are generated by an advertising agency working with a client to develop a commercial using a storyboard as a framework or by a director to accurately communicate a visual idea. When the commercial is approved for production, the final storyboard is provided to a video production company, which organizes the film production based on the storyboard. The process of filming a storyboard is logistically complex and creatively demanding, as the storyboard must be “brought to life” as a video. To provide input on artistic elements of video production, clients and advertising agencies coordinate with the production company to provide input and feedback on production. To streamline filming and reduce production costs, the client and advertising agency are often physically present during video production to provide real-time input. Although travel and time required for in-person attendance are costly, efficiencies are ultimately realized by eliminating re-takes and ensuring alignment on aspects of the video as filming progresses. When the client and/or advertising agency cannot be present (e.g., due to cost, schedule conflicts, travel restrictions, etc.), video producers must find other ways to communicate and incorporate client feedback. Presently there exists a need for a platform that supports real-time collaboration between video producers, clients, and advertising agencies from remote locations.

### BRIEF SUMMARY

Embodiments of the present invention solve these and other needs by providing a real-time video production collaboration platform (RTVCP). An exemplary RTVCP includes a method that includes accessing a project file comprising a first storyboard image associated with a first scene, receiving a first live video feed from a first location, associating the first live video feed with the first storyboard image, and transmitting, to a second location, an interface juxtaposing the first live video feed with the first storyboard image. The method further comprises associating a first portion of the first live video feed with a first take of the first scene, associating a second portion of the first live video feed with a second take of the first scene, receiving, from one of the first location and the second location, a selection of one of the first and the second takes, and associating the selection of one of the first and the second takes with the project file. The method may also include generating an electronic report comprising the first storyboard image and information identifying the selection of one of the first and the second takes. The method may also include playing back previously captured takes and associating a take with the corresponding storyboard image and notes.

In certain embodiments, a method further includes receiving a second live video feed from the first location, the second live video feed corresponding to a different shot than the first live video feed, wherein the first live video feed and the second live video feed are simultaneous. The method additionally includes associating the second live video feed with the first storyboard image, transmitting, to the second location, an interface juxtaposing the second live video feed with the first storyboard image and the first live video feed, associating a first portion of the second live video feed with the first take of the first scene, associating a second portion of the second live video feed with a second take of the first scene, and receiving, from one of the first location and the second location, a selection of one of the first portion of the first live video feed, the second portion of the first live video feed, the first portion of the second live video feed, and the second portion of the second live video feed. The electronic report further comprises information identifying the selection of one of the first portion of the first live video feed, the second portion of the first live video feed, the first portion of the second live video feed, and the second portion of the second live video feed.

### BRIEF DESCRIPTION OF THE DRAWINGS

FIG. 1 illustrates a launch interface according to certain embodiments of a RTVCP.

FIG. 2 illustrates an example of a project interface in certain embodiments of the RTVCP.

FIG. 3 illustrates an example of a board interface in certain embodiments of the RTVCP.

FIG. 4A illustrates an example of a scene interface in certain embodiments of the RTVCP.

FIG. 4B illustrates an example of a scene interface in certain embodiments of the RTVCP.

FIG. 4C illustrates an example of a scene interface in certain embodiments of the RTVCP.

FIG. 5 illustrates an example of an interface in certain embodiments of the RTVCP.

FIG. 6 illustrates an example of a setup interface in certain embodiments of the RTVCP.

FIG. 7 illustrates an example of a configuration interface in certain embodiments of the RTVCP.

FIG. 8 illustrates an example of an interface for a video production project supported by embodiments of a RTVCP.

FIG. 9 illustrates an example of an interface for a video production project supported by embodiments of a RTVCP.

FIG. 10 illustrates an example of an interface for a video production project supported by embodiments of a RTVCP.

FIG. 11 illustrates an example of an interface for a video production project supported by embodiments of a RTVCP.

FIG. 12 illustrates an example of an interface for a video production project supported by embodiments of a RTVCP.

FIG. 13 illustrates an example of an interface for a video production project supported by embodiments of a RTVCP.

FIG. 14 illustrates an example of an interface for a video production project supported by embodiments of a RTVCP.

FIG. 15 illustrates an example of an interface for a video production project supported by embodiments of a RTVCP.

FIG. 16 illustrates an example of an interface for a video production project supported by embodiments of a RTVCP.

FIG. 17 illustrates an example system for use with embodiments of a RTVCP.

FIG. 18 illustrates a flow chart demonstrating certain aspects of the performance of the RTVCP.

### DETAILED DESCRIPTION

Embodiments of the present invention comprise a real-time video production and collaboration platform (RTVCP) that facilitates among other things, presentation and editing of electronic storyboard files, juxtaposition of electronic storyboard files and images with live video, capturing and processing input from remote participants (e.g., clients and/or advertising agencies) in real time, facilitating can capturing markups and revisions to the electronic storyboard file during filming, and generating reports that present notes and revisions during production in an organized and efficient manner.

An example RTVCP according to the disclosure may include a software application stored in a non-transitory computer-readable medium and executed by one or more processors. The application may be accessible via web browser or downloadable by participants in the video production process on any applicable electronic device (e.g., PC, tablets, mobile devices, etc.). A user is given access based on his/her role (e.g., administrator or user). Typically the video producer will be the RTVCP system administrator with full access to management, creation, writing and editing functionality, while clients receive read-only or restricted editing access and individualized account settings and view options.

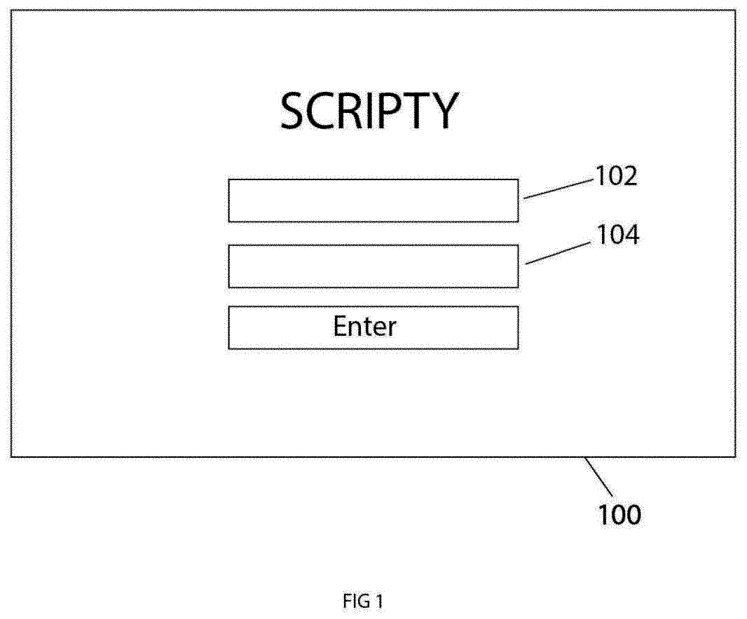

FIG. 1 illustrates an example launch interface 100 for a RTVCP. The launch interface includes username field 102 and password field 104 to receive login credentials for access to the RTVCP platform. Typically, the launch interface is accessed via a web browser or dedicated application.

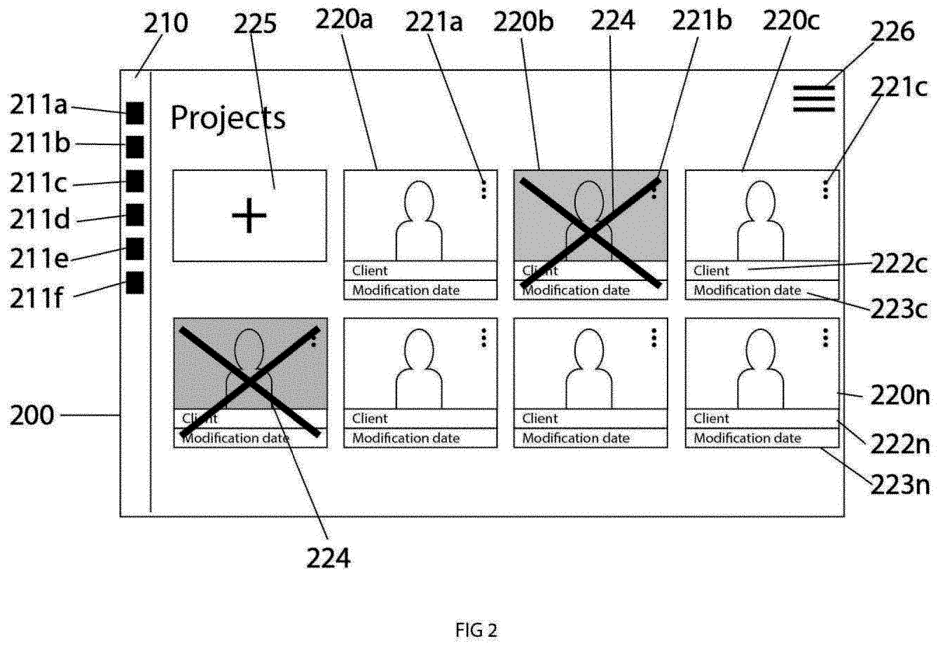

FIG. 2 illustrates an example project menu interface 200 presented to an administrator after logging in to the RTVCP. A vertical menu bar 210 at the left includes project menu icons 211a-211f for various interfaces and functional modes, including PRODUCER, DIRECTOR, 1AD, SCRIPTY, and READ-ONLY. The primary PROJECTS window shown in FIG. 2 displays a plurality of project tiles 220, each representing a particular project (220a, 220b, 220c, . . . , 220n). Each project tile 220 includes information fields 222 (with exemplary labeled fields 222c and 222n) and 223 (with exemplary labeled fields 223c and 223n) which may include information such as a title, client name, and date fields identifying the associated project. Indicating icons 224 such as the “X” mark shown over the third tile on the top row (220b) and the first tile on the second row indicate projects that are completed. As apparent to one of skill in the art, icons other than check marks may be used. Each tile may also contain a context menu button 221 (shown by exemplary 221a, 221b, 221c) which, when selected, may present options relevant to an entire project. From this window, any project may be selected for beginning or continuing a workflow through the RTVCP. In addition, new projects may be created by selecting the new project tile 225 at the top left of the window. Selecting the new project tile generates a dialog box permitting a user to input information corresponding to the new project. View options button 226 present a view options menu that enables a user to customize the view of projects by preference such as by name, date modified, date created, or status. Other options for viewing may also be available, such as the ability to filter certain project types.

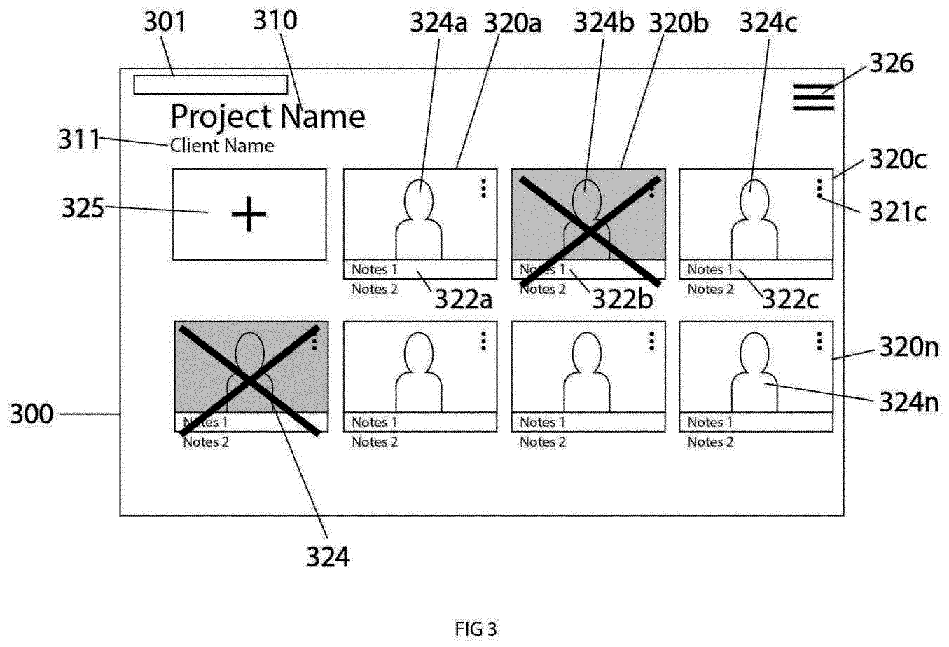

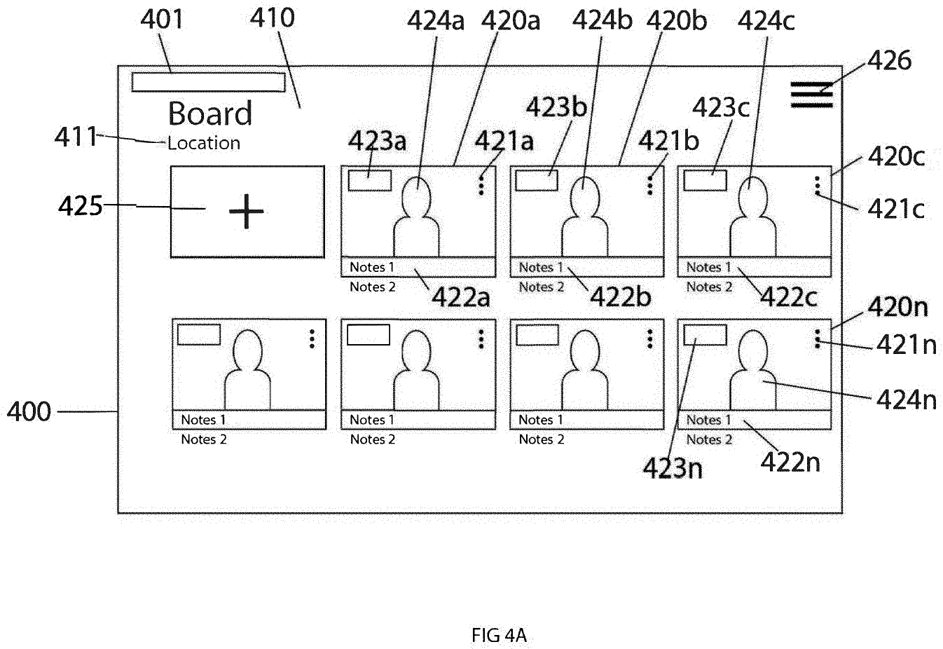

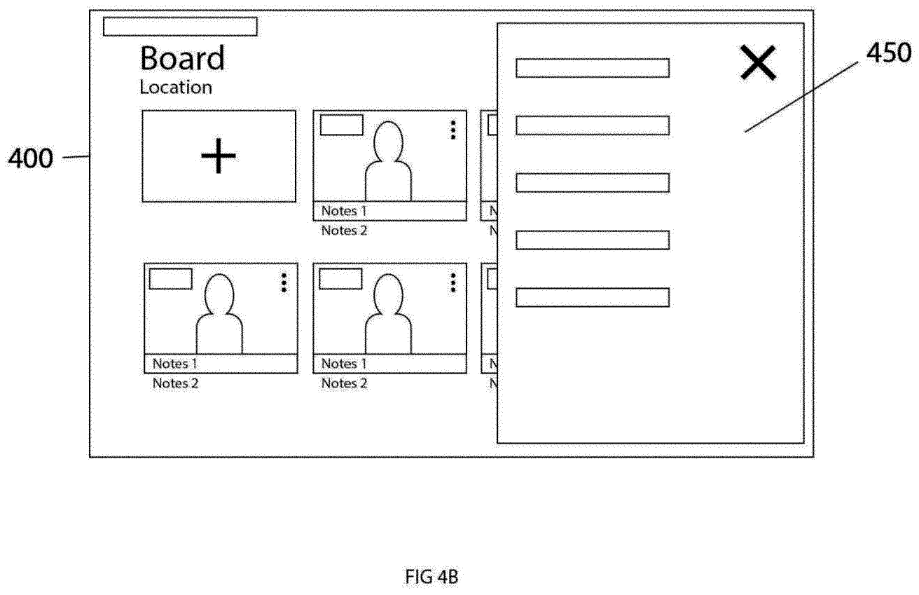

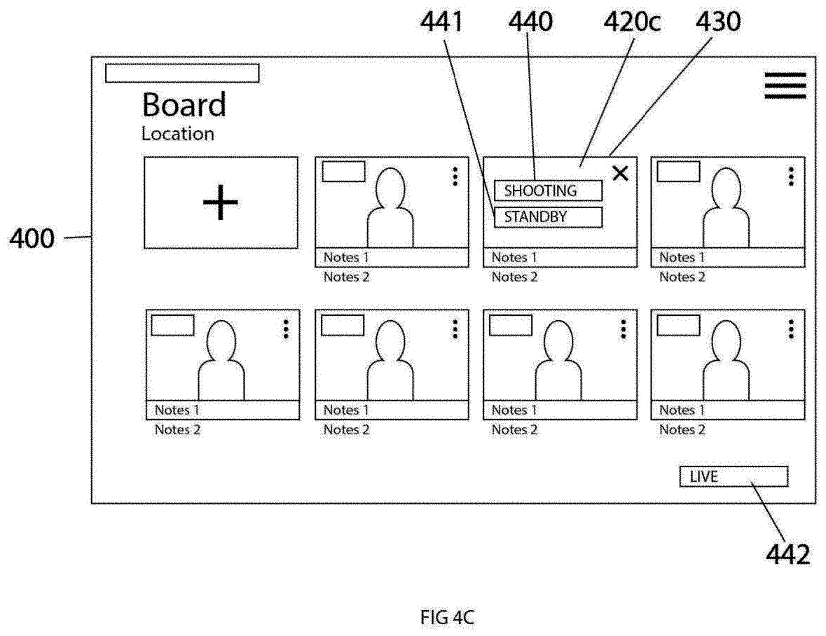

FIG. 3 illustrates an example of a board configuration interface 300 presented to an administrator after selecting a particular project tile for configuration from project menu interface 200. The board configuration interface 300 includes a hierarchy indicator 301 that indicates the location of the user in the hierarchical interface provided by the RTVCP. The board configuration interface 300 contains a project name field 310 and client name field 311, together with a series of board tiles 320 each corresponding to a scene (320a, 320b, 320c, . . . , 320n). Each board tile 320 may include a board thumbnail image 324 (e.g., 324a, 324b, 324c, . . . 324n) which may be imported and selected by the administrator from a storyboard file so that each board tile shown in a project corresponds to a storyboard image. Each board tile 320 includes a thumbnail image 324 from the storyboard, and a board text field 322 (shown by exemplary 322a, 322b, 322c) that may include any useful annotations and/or information about the shots and scenes (e.g., movement/action of actors, props, or environment, number of shots), sounds (e.g., voice over, dialogue, music, etc.) and camera directions (e.g., focal points, zoom, movement, etc.). Option menu button 321 (shown by exemplary 321c) is provided and, when selected, will provide a user a dialog box to enable the user to select various board options. As will be apparent to one of skill in the art, the board thumbnail images displayed in the example of FIG. 3 are generic placeholders. Typically, as a project is defined, custom images from a storyboard associated with the project will be selected (either manually by a user during a configuration step or automatically by file import or processing) for each board tile. New board tile 325 allows a user to create a new board. After selecting new board tile 325, a user is prompted to input information about the board, including information such as scene name and a location, as well as additional information regarding the scene. Board options button 326 is also provided on board configuration interface 300. Selecting board options interface 326 will provide a user with a project settings window, described further below in FIG. 4B.

FIG. 4A illustrates an example of a shot configuration interface 400 presented to an administrator after selecting a particular project tile for configuration from board menu interface 300. The shot configuration interface 400 includes a hierarchy indicator 401 that indicates the location of the user in the hierarchical interface provided by the RTVCP. The project configuration interface 400 contains a board name field 410 and location name field 411, together with a series of shot tiles 420 each corresponding to a shot or scene (420a, 420b, 420c, . . . , 420n). Each tile 420 may include a shot thumbnail image 424 (e.g., 424a, 424b, 424c, . . . 424n) which may be imported and selected by the administrator from a storyboard file so that each tile shown in a project corresponds to a storyboard image. Each shot tile 420 includes a user-definable shot and scene number 423a, 423b, 423c, . . . , 423n (e.g., 1A may denote scene 1 shot A), a thumbnail image 424 from the storyboard, and a shot text field 422 that may include any useful annotations and/or information about the shots and scenes (e.g., movement/action of actors, props, or environment), sounds (e.g., voice over, dialogue, music, etc.) and camera directions (e.g., focal points, zoom, movement, etc.). Text field 422 may also indicate items of interest such as shot prefix information and take numbers. Option menu button 421 (e.g., 421a, 421b, 421c, . . . 421n) is provided and, when selected, will provide a user a dialog box to enable the user to indicate particular live shooting updates. As will be apparent to one of skill in the art, the shot thumbnail images displayed in the example of FIG. 4A are generic placeholders. Typically, as a project is defined, custom images from a storyboard associated with the project will be selected (either manually by a user during a configuration step or automatically by file import or processing) for each shot tile 420. New shot tile 425 allows a user to create a new shot tile. After selecting new shot tile 425, a user is prompted to input information about the board, including information such as scene name and a location, as well as additional information regarding the scene. Shot options button 426 is provided on shot configuration interface 400. Selecting shot options button 426 will present a project settings interface as shown below in FIG. 4B.

Scene numbering, project sharing, reporting, and the like may be configured via project settings interface 450 such as the example shown in FIG. 4B. In the illustrated embodiments of FIGS. 3 and 4A, selecting shot options button 426 or board options button 326 causes the project settings window to appear, allowing the administrator to configure default numbering for scenes and shots, custom credentials (e.g., URLs and passwords) for sharing access to the project, reporting recipients, etc.

FIG. 4C illustrates a shot configuration interface 400 once a user has selected option menu button 421 on a particular shot tile 420. In the illustration provided in FIG. 4C, option menu button 421c (of FIG. 4A) corresponding to shot tile 420c (of FIG. 4A) has been selected. In response, the user interface provides live shot information fields in production control interface 430. Selectable shooting field 440 may be selected by the user to indicate that the shot is currently shooting. Once selectable shooting filed is selected, live production indicator 442 may display on shot configuration interface 400. In some embodiments, live production indicator 442 may also display on other interface screens of the RTVCP such as board configuration interface 300 or project configuration interface 200. Selectable standby field 441 may also be presented to a user. After selecting selectable standby field 441, a user is presented with timer options which causes the user interface of the RTVCP to present a countdown timer indicating to users of the system that a new live shot may be about to begin.

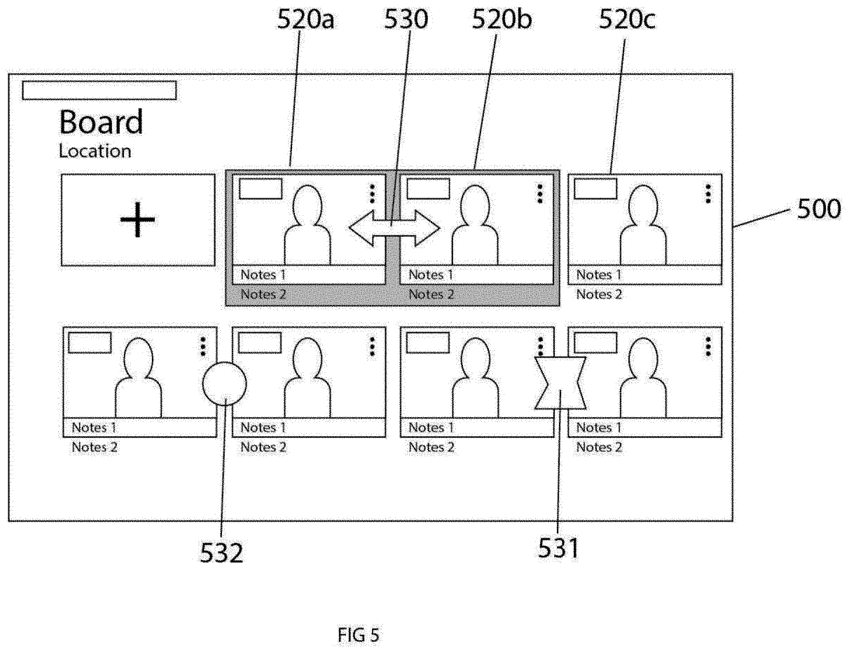

FIG. 5 illustrates an example shot configuration interface 500 presented to an administrator. This interface allows an administrator to add, organize, associate, and annotate shots or scenes in the planning phase of a video production project. As noted above, each tile is a storyboard image corresponding to a shot or scene (e.g., 520a, 520b, 520c) of the planned video project. Although the example shown includes generic scene and shot descriptors, a live project will include tiles corresponding to shots and scenes with unique numbers and text descriptions useful for production and editing. An administrator may additionally add, delete, and rearrange tiles, add notes, and incorporate shot relationships 530, 531, or 532 such as those shown in FIG. 5 (e.g., “CONTINUOUS,” “MATCH OUT,” “VFX,” etc.). The RTVCP may include additional scene planning and editing features; those shown in the example are merely illustrative.

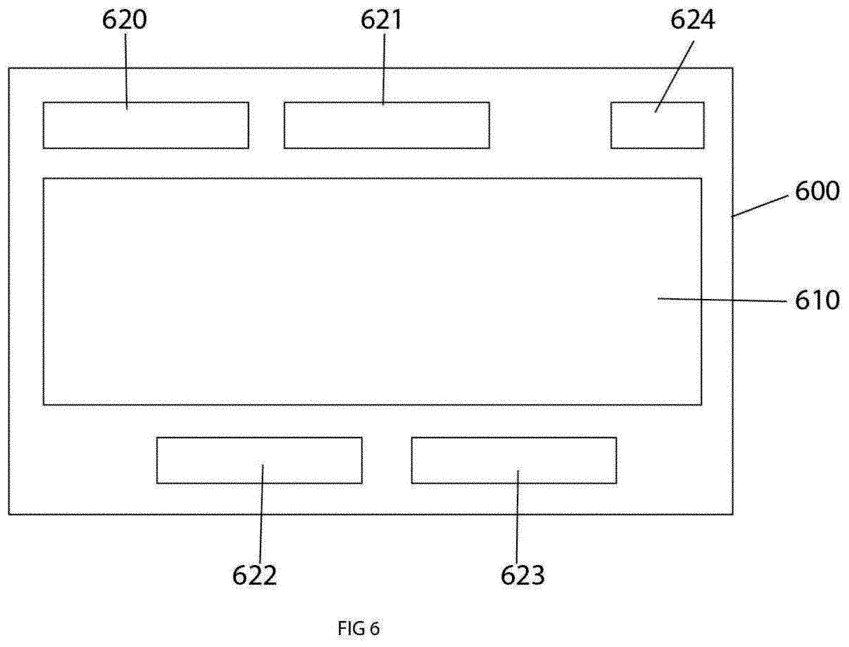

FIG. 6 illustrates a scene setup interface 600 presented to an administrator after selecting the new shot tile 425 in the shot configuration interface 400. The scene setup interface 600 interface allows the administrator to specify a storyboard image 610 for a particular scene, define scene numbering, and specify a shooting day. Prefix indicator 620 allows a user to specify a prefix to be used with shot identification. Setup indicator 621 allows a user to indicate a string related to the particular shot. Description field 622 and notes field 623 allow for a user to further input additional information related to the scene or shot. In certain embodiments, an imported storyboard file may be automatically parsed and separated into scenes via software using image processing and analysis algorithms. In other embodiments, the administrator may manually extract and/or select images in a storyboard file for each scene tile in the project.

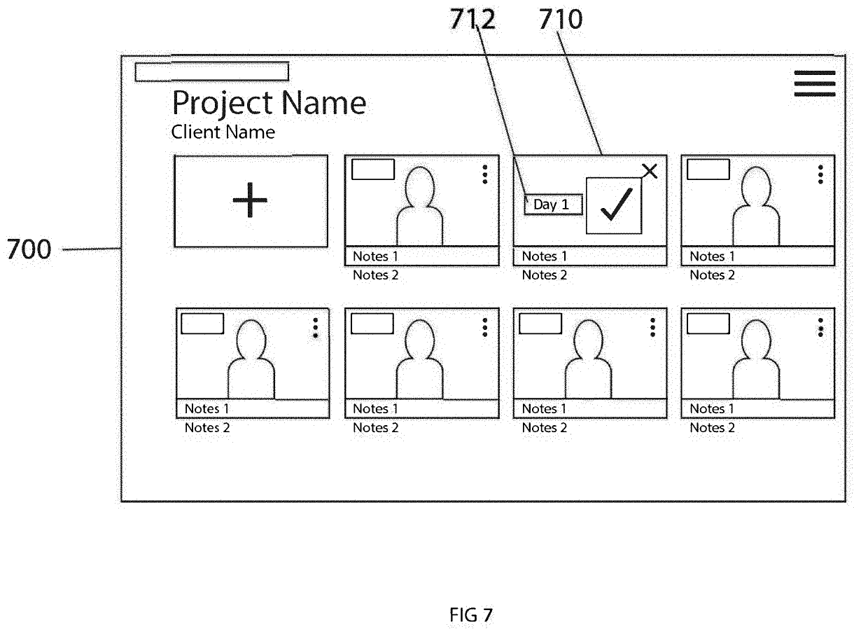

FIG. 7 illustrates an example shooting configuration interface 700 presented to an administrator. This interface allows an administrator to plan video shooting by, for example, selecting a scene, bringing up a scene assignment menu 710, and assigning the scene to a shooting day (e.g., “DAY 1”) in scene date field 712. A shooting settings menu (not shown) may be used to specify the total number of shooting days, locations, etc.

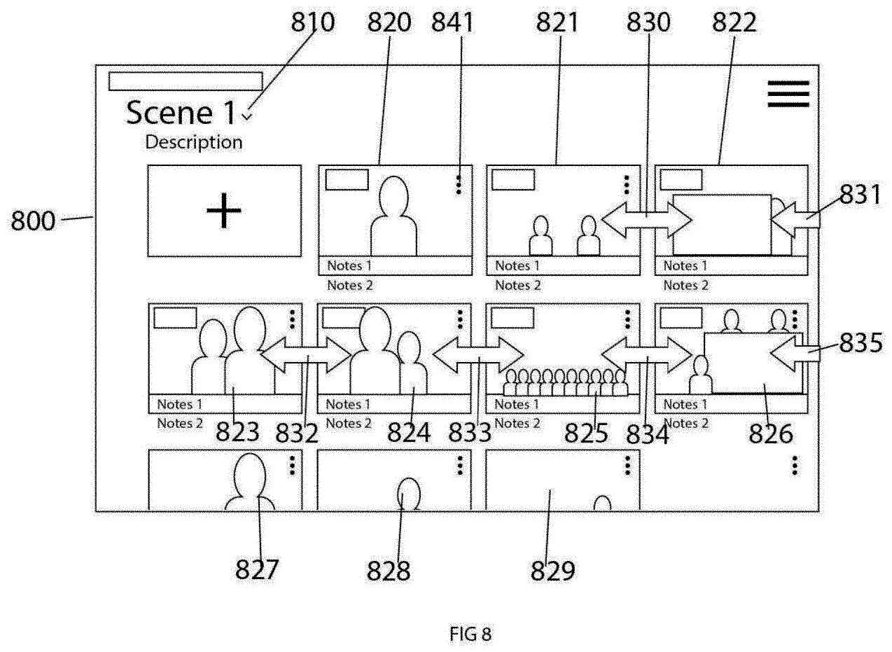

FIGS. 8-16 illustrate examples of how certain embodiments of the RTVCP can be used to improve collaboration and efficiency during a video production project.

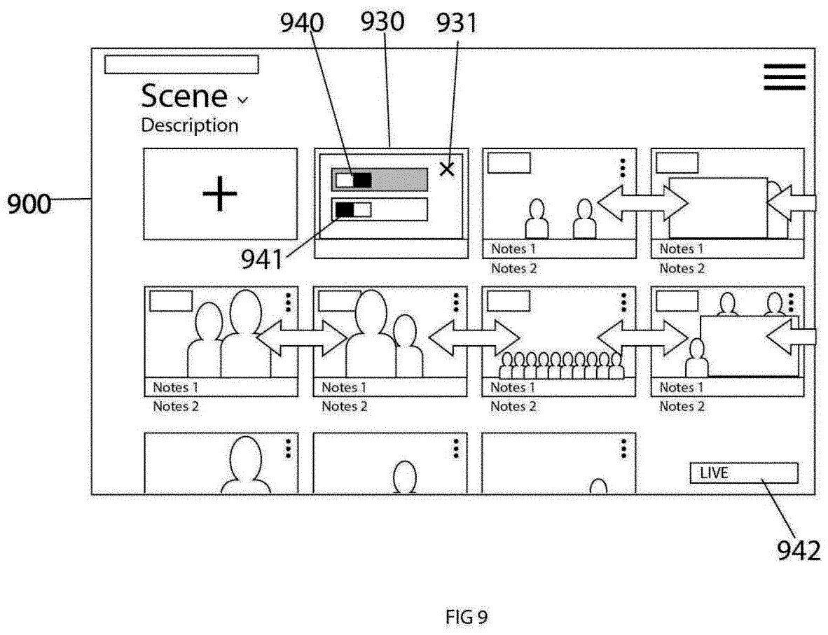

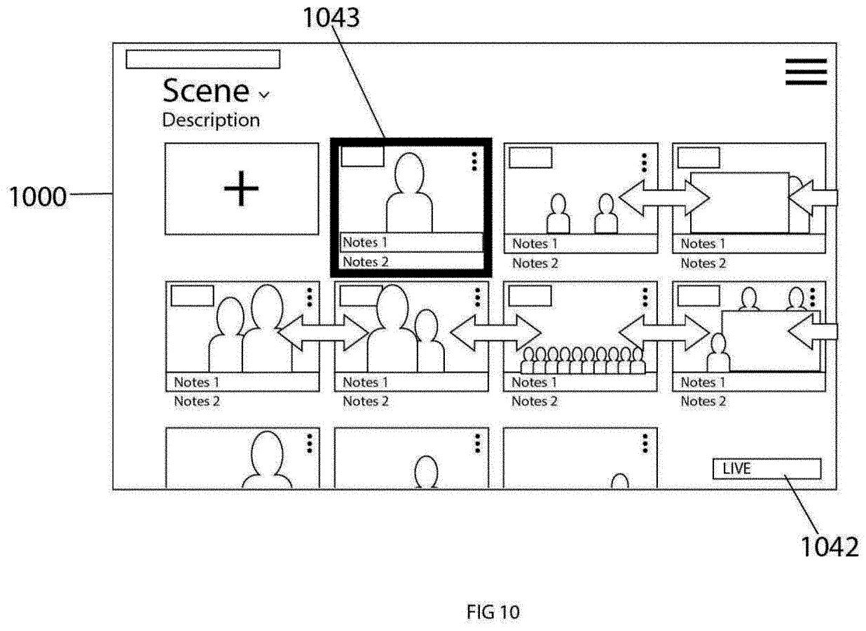

FIG. 8 illustrates an example scene selection interface 800 for an example project presented to an administrator of the RTVCP. In this example, “Scene 1” was selected from a scene pulldown menu 810 at the top left. In response, the window primarily displays the storyboard tiles for Scene 1: Scene 1-A (tile 820), Scene 1-B (tiles 821-827) (seven tiles in total, associated by arrows 830-835 denoting a continuous shot), Scene 1-C (tile 828), and Scene 1-D (tile 829). Notes and a description associated with the tiles and scenes may also displayed. The administrator may configure the description appearing with the storyboard tiles and add any production notes as desired. Hovering a cursor over Scene 1-A reveals a selectable menu icon (indicated by three vertical dots 841 in the top right of the storyboard tile for Scene 1-A). Selecting the menu icon in this example displays a production control interface 930 as shown in the scene selection interface 900 of FIG. 9. The production control interface allows the administrator to select this particular scene for shooting (current) by activating the selectable shooting field 940 or standby (next) by activating the selectable standby field 941. In FIG. 9, the user has indicated that Scene 1-A is currently shooting, causing the “Live Production” indicator 942 to appear in the bottom right of the scene selection interface. Closing the production control interface 930 by selecting the close menu icon 931 (here, by selecting the small “x” in the top right corner of the tile) returns the user to scene selection interface 1000 shown in FIG. 10. The “Live Production” indicator 1042 remains in the bottom right corner, and Scene 1-A is highlighted by accent border 1043 (e.g., a red box) to indicate that this scene is in live production.

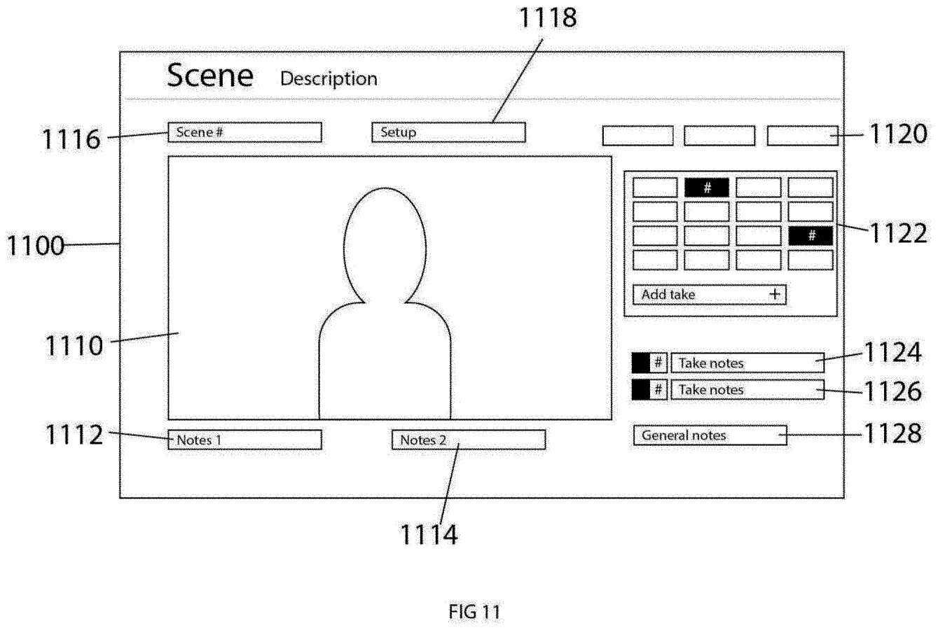

FIG. 11 illustrates a project scene interface 1100 (here, Scene 1-A) presented to an administrator of an example RTVCP. In this embodiment, selecting Scene 1-A from the interface of FIG. 10 opens the interface shown in FIG. 11. The Scene 1-A project scene interface 1100 shown includes the storyboard image 1110 for Scene 1-A, the description field 1112 and notes field 1114 for the scene entered by the administrator, the prefix field 1116 and setup information 1118 for the scene, and additional features accessible via features menu 1120 on the right that includes selectable tabs for “TAKES,” “STATUS,” and “CONTROLS.” In this view, the “TAKES” tab is selected, and a list of takes 1122 for this scene is displayed. The administrator may select specific take numbers for comment. This concept, referred to in this example as “circling takes,” allows the administrator (e.g., video producer) to associate specific notes with takes on the fly during production using an interface of the RTVCP. For example, during filming of Scene 1-A, a production editor may virtually “circle” Takes 2 and 12 by selecting related icons on a touch screen and add descriptive notes into take notes field 1124 or take notes field 1126 (e.g., “best shot,” “great light”) for each with voice command, key input, or the like. Additional take notes fields will be presented for each “circled” take. Other general notes regarding the takes may be input by a production editor by using the general notes field 1128. This features facilitates quickly capturing information on-the-fly during production with minimal delay and disruption to the process. Moreover, as described below, the captured information may be automatically and in real time imported in other interfaces, shared with the client, and included in reporting.

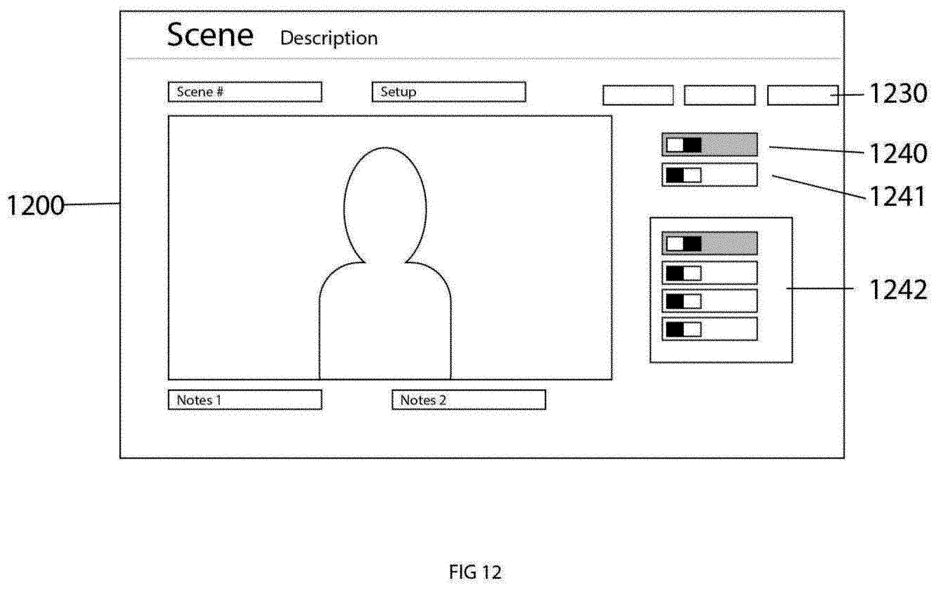

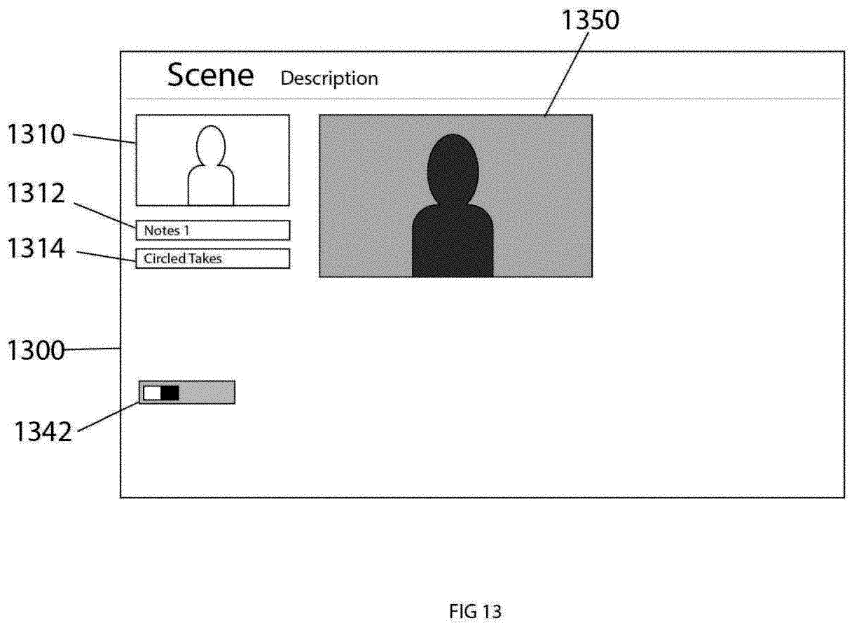

FIG. 12 illustrates a project scene interface 1200 (here, Scene 1-A) presented to an administrator in which the “CONTROLS” tab 1230 is selected. In this view, the administrator may specify the selected scene as currently shooting (Shooting) or next to shoot (Standby) by selecting either selectable shooting field 1240 or selectable standby field 1241, and may further specify one or more live streams from live stream selection fields 1242 to include for the scene view presented to a client. In this example, four cameras are selectable (Cameras A-D) for live streaming, but only Camera A is selected. As a result, a live feed from Camera A on the production site may be transmitted to a client interface (e.g., the example shown in FIG. 13).

FIG. 13 illustrates an example live production interface 1300 presented to a client in an example RTVCP. In this embodiment, the storyboard image 1310 for Scene 1-A is displayed in a first window on the left, together with the administrator's notes and description in notes and description listing 1312, as well as an indication of circled takes in circled takes listing 1314. A live video feed 1350 from the Camera A at the shooting location is transmitted to the RTVCP (e.g., via an encoder) and displayed to a client in a second window on the right. In this manner, the storyboard image 1310 and a real-time production video feed 1350 are simultaneously presented in juxtaposition.

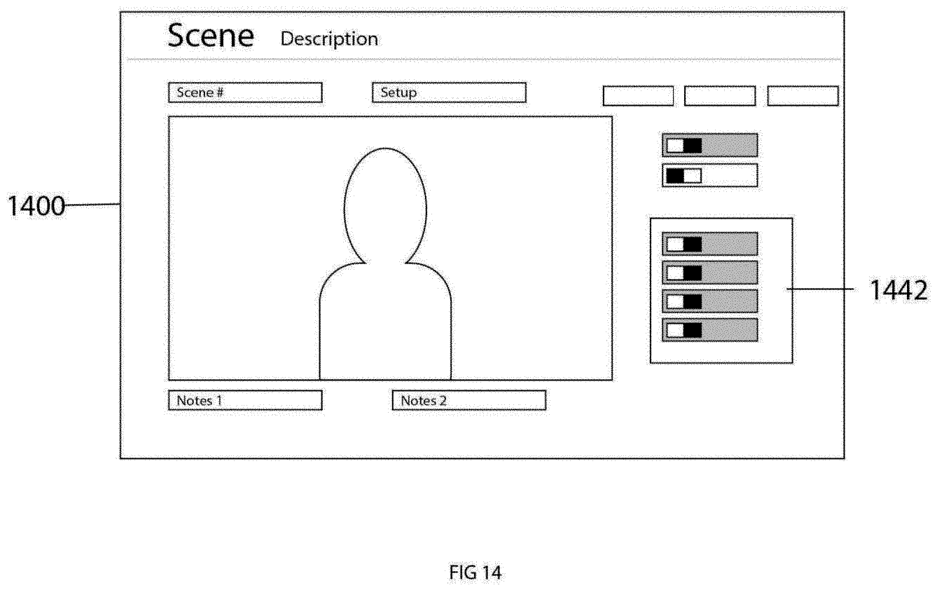

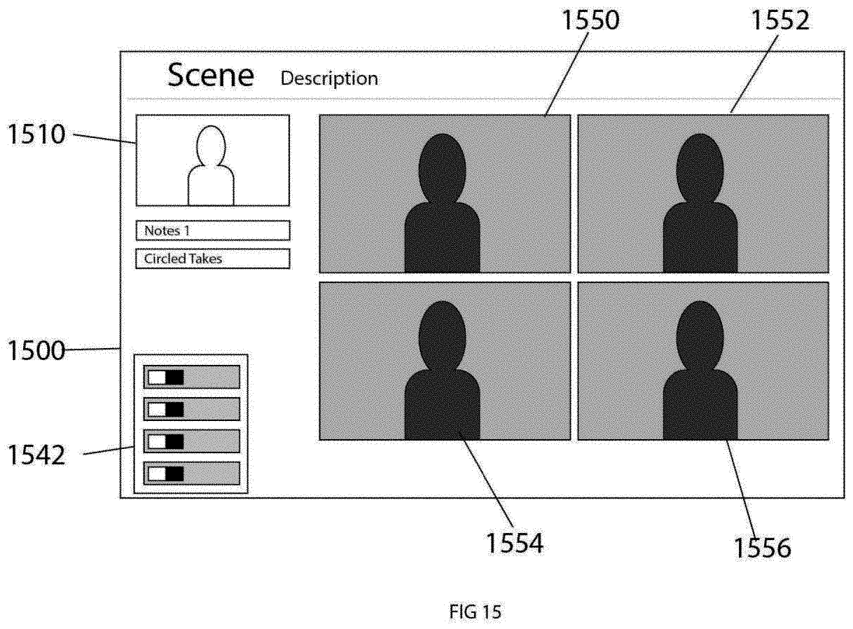

In the example of FIG. 13, a single live video feed 1350 for Camera A is shown. In practice, however, additional video feeds may be included for additional cameras. FIG. 14 illustrates a project scene interface 1400 analogous to FIG. 12 in which four cameras (Cameras A, B, C, and D) are available and selected for live streaming, as shown in live stream selection fields 1442. Accordingly, FIG. 15 illustrates an example live production interface 1500 (analogous to FIG. 13) presented to a client with four live streams, 1550, 1552, 1554, and 1556, one from each of Cameras A, B, C, and D. Again the video streams are juxtaposed and presented simultaneously with the storyboard image 1510 for the scene. Cameras A-D may each present different views or perspectives of the scene, allowing the collaborators in the video production process to assess even more shots on-the-fly during production. Live stream selection fields 1542 may also be presented to a user in project scene interface 1500 to permit selective display of live streams as desired.

Accordingly, embodiments of the RTVCP disclosed herein allow an on-site video production team to provide real-time video feeds to clients located off-site. Hence, remote clients and participants (e.g., clients, ad agencies, etc.) are able to see how shots look on screen, communicate with the video production team (via audio, visual, textual, or other means, including via the RTVCP itself in certain embodiments), provide feedback, suggest changes, evaluate results, and otherwise contribute to the video production process in real time. Moreover, juxtaposing the live video feed of the scene with the storyboard image for the scene helps clients and production teams compare actual shots with the creative vision conveyed in the storyboard, and data capture features of the RTVCP ensure that feedback and impressions are immediately recorded. In one embodiment, notes may be given by a client team while a shot is being recorded.

For example, the video producer may shoot a take for Scene 1-A using one or several cameras relaying a live video feed to the RTVCP. Client representatives located remotely and logged into the RTVCP are able to view the live shots juxtaposed with the storyboard image, presented in real time via a RTVCP interface. As the shot concludes, the clients may provide feedback that the video producer captures in the RTVCP. For example, if the feedback is positive, the video producer may virtually “circle” the take and adding notes reflecting the client's feedback or impressions.

By simultaneously presenting video of live shots with the storyboard inspiration, and capturing feedback on the fly, embodiments of the RTVCP enable collaborators in the video production process to assess the shots more accurately, provide, capture, and respond to feedback more quickly, and align on content for the final product while video production is ongoing. This may expedite production and reduce costs by reducing or eliminating the need for retakes and in-person attendance on scene, and reducing the time required for editing and production after shooting has ended.

It should be understood that the interfaces illustrated herein are examples only, and the RTVCP may have any appropriate interfaces to support the functionality described. It should also be understood that the RTVCP may include additional features and functions for working with pre-recorded video. That is, aspects of the RTVCP disclosed herein are not limited to live or real time video applications. For example, embodiments of the RTVCP may include video editing features and interfaces that enable a user to review video footage recorded previously and associate portions of the video (e.g., takes) with particular storyboard images and/or notes in the RTVCP.

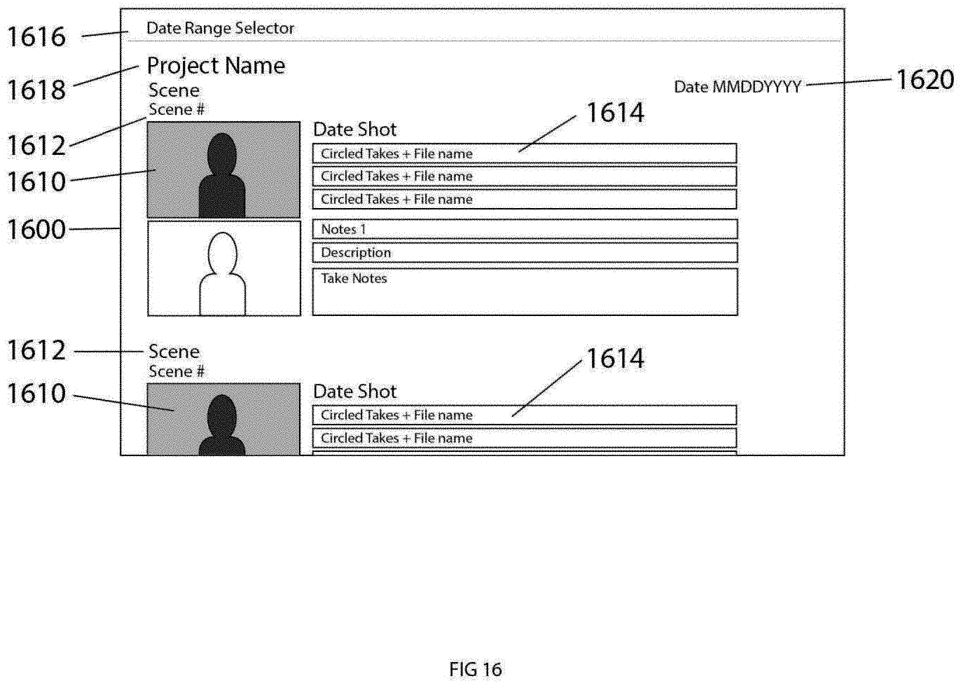

FIG. 16 illustrates an example script report 1600 for a project file of an RTVCP. At any point during a product, an administrator or client may generate a project report summarizing information captured by the RTVCP. In this embodiment, the report includes file information such as a start and end date 1616, project name 1618, and a script report date 1620. A body of the report includes, for each scene, the storyboard image 1610, scene number 1612, and shot details 1614 such as shot date, circled takes, a description, and notes. The report may be automatically generated or selectively generated in response to a command, and may be distributed to the video production team and clients electronically or otherwise. Script report 1600 may be presented in a web format as shown here, but may also be able to provide a printed format (not shown), such as a PDF file.

In addition to providing a script report, the RTVCP may be configured to create daily video file which permits a user to view circled all circled takes from a particular day of shooting. The daily video file may be presented on a web interface which, similar to script report 1600, includes details such as scene numbers, shot date, circled takes, description, and notes.

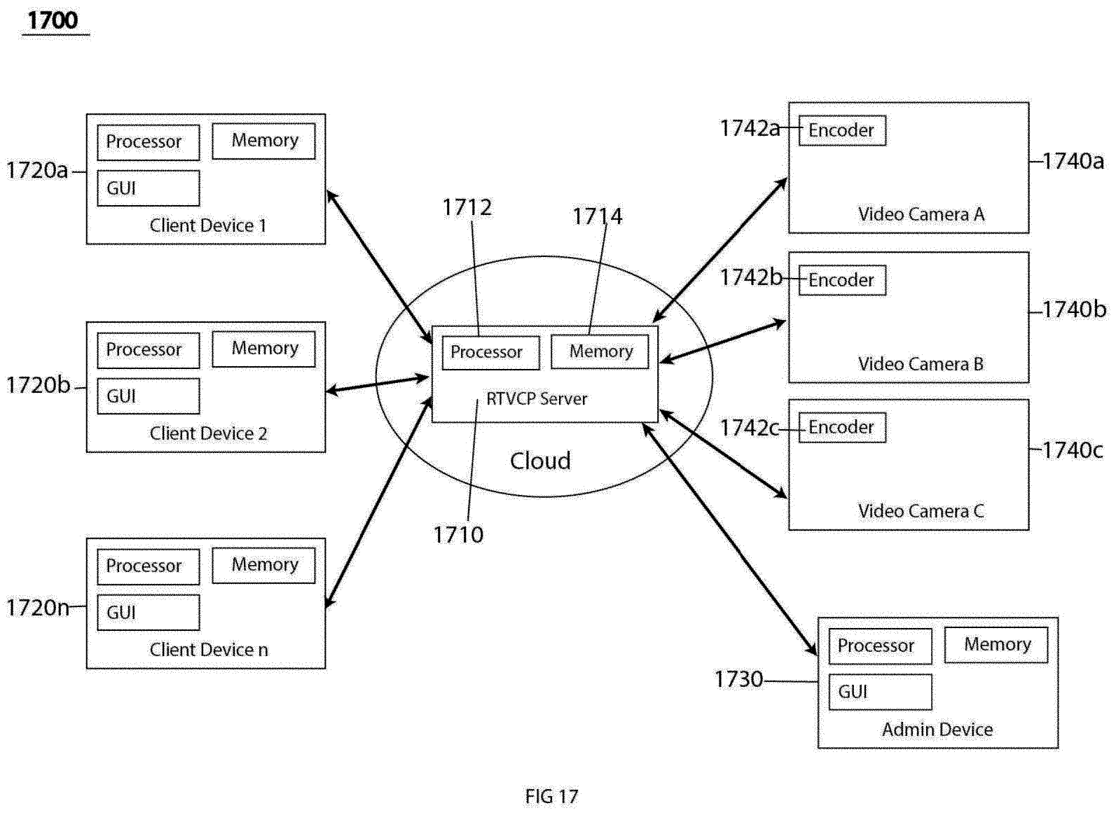

FIG. 17 illustrates an example RTVCP system 1700. Included in the system is a RTVCP server 1710 comprising a processor 1712 and memory 1714 storing executable instructions for proving the RTVCP described herein. In certain examples, the RTVCP server comprises a web server that supports the communications and interfaces described and illustrated above. Client Devices 1720a, 1720b, . . . , 1720n and Admin Device(s) 1730 may be conventional PCs, laptops, mobile devices, tablets, etc. running a web browser or compatible application program. For example, the RTVCP server 1710 communicates with an Admin Device 1730 to configure a project as shown in FIGS. 2-7 above. The RTVCP server 10 communicates with the Admin Device 1730, Video Camera(s) 1740a, 1740b, . . . , 1740n, and Client Device(s) 1720a, 1720b, . . . , 1720n during production to, for example, receive live video feeds associated with scenes or projects, relay live video feed juxtaposed with storyboard images to client devices, and receive selections and notes from an Admin Device 1730. Each camera 1740 may be equipped with its own encoder 1742 (e.g., 172a, 1742b, 1742c). The encoder may be separate hardware that attaches to the camera or may be software included within the camera. Encoder 1742 is configured to convert a video stream from one format to a compressed format that is suitable for use by the RTVCP. In many production environments, high resolution data is captured by a camera that may not be necessary for use in a review setting and may be too large to be effectively transmitted to a cloud server, which may only accept files of a certain size or streams of a certain quality or format. Thus, encoder 1742 will transcode camera data to a suitable format for transmission to and storage on RTVCP server 1710. Notably, the transmission of transcoded data from encoder 1742 occurs in real time so that a remote user can provide immediate feedback to a production team that is on location conducting filming. Encoder 1742 may also capture metadata from camera 1740 such as filename and shot parameters such as focal length, location and time, hard drive number, and the like. Encoder 1742 will then transmit this metadata in a suitable format along with transcoded video data so that RTVCP Server 1710 may organize and interpret this metadata.

The distributed architecture of the RTVCP system permits operation while each Client Device, Admin Device, and Video Camera is in a different location. Components of the RTVCP system shown in FIG. 17 includes one or more processors, memory, and computer-executable instructions stored in the memory for supporting the features and performing the functions described herein.

Although a number of features have been discussed above, when accessing the RTVCP system, different users may have different permission sets. For example, an administrative user have be permitted to have control over user accounts and view/adjust certain features such as adjusting billing details or tweaking certain notifications.

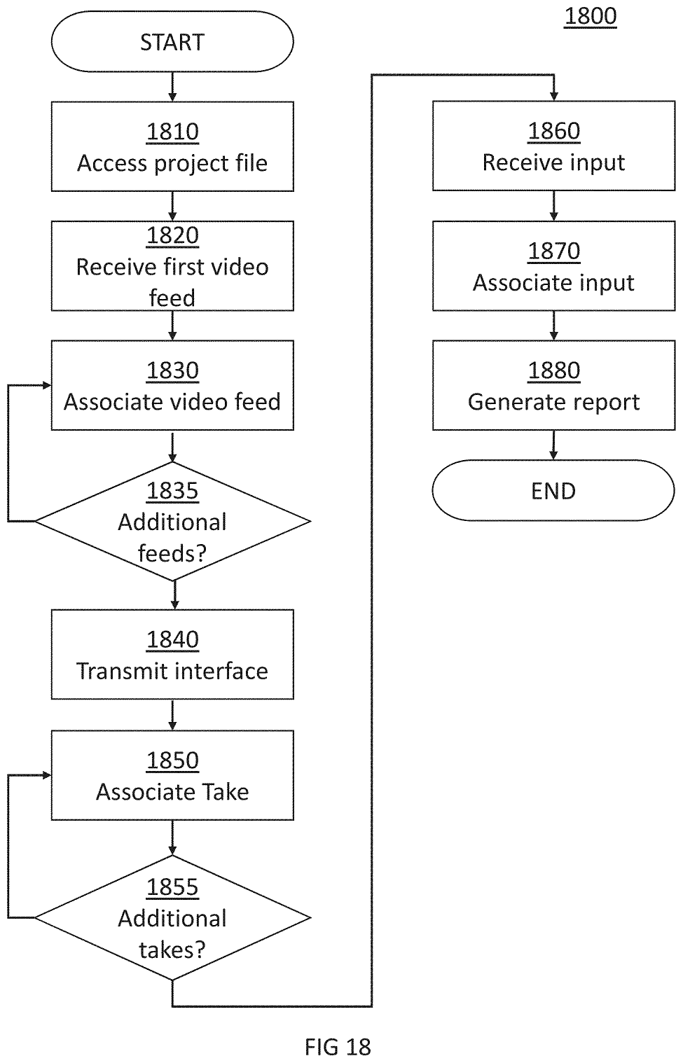

FIG. 18 illustrates a flow diagram depicting an example of the RTVCP system operating to present data to a user. In process 1800, the RTVCP system begins at step 1810 by accessing a project file which includes at least a first storyboard image associated with a first scene. Typically, the storyboard image associated with the first scene has previously been input to the system. At step 1820, the RTVCP then receives a first live video feed from a shooting location. In certain situations, the video feed may not be live, but may instead have already been stored on the RTVCP and may be presented to the user after shooting. At step 1830, the RTVCP then associates the received video feed with the first storyboard image associated with the first scene. At step 1835, the RTVCP evaluates whether additional feeds have been enabled for the first scene. If there are additional feeds enabled, the RTVCP will receive an additional feed and associate that video feed with the first scene as in step 1830. Once all selected feeds have been associated, RTVCP will transmit to an interface to a second location at step 1840. The second location may be a remote location (such as a location that is geographically distant from the shooting location, e.g., cross-country), or may be nearby the shooting location but separated in some way from the actual camera capturing devices (i.e., the user at a second location is not looking directly at the viewfinder of a camera shooting a feed). The transmitted interface will juxtapose the video feed(s) with the storyboard image that was associated with the scene, for example as disclosed above in accordance with FIGS. 11-15. At step 1850, the RTVCP will associate a portion of one of the video feeds with a take of the first scene. As depicted at step 1855, if there are additional takes, the RTVCP system may associate another portion of one of the video feeds with another take of the first scene. This step may repeat as desired while additional takes are being captured by the production site. The RTVCP may automatically register from metadata that an additional take is underway, or a user at the shooting location may manually indicate that a new take is underway. At step 1860, the RTVCP receives input from either the shooting location or the second location. This input may be, for example, an indication selecting a particular take (e.g., circling a take) or may be another indication such as note regarding a particular take. Notes regarding a particular take may be received in real time or after a shot has finished. The received input is associated with the project file at step 1870 so that it may be presented to a user or accessed at a later time. In step 1880, a report is generated which includes scene data, such as the storyboard image, and information regarding the takes, such as circled takes, notes, or other indications. The report may be limited to a particular scene or may include multiple scenes. Additionally, the report may correspond to a single day or multiple days. In some instances, the report is a web interface as depicted in FIG. 16. In other instances, a user of the system may request a printable PDF report, or another printable format. In some embodiments, the RTVCP may present all of the takes of a particular day as a daily file, namely a video file with all circled takes concatenated for easy review.

Embodiments disclosed herein are exemplary in nature and do not limit the scope of the inventive RTVCP. One skilled in the art will recognize that certain features and functions of the RTVCP disclosed herein may be modified, combined, or altered without departing from the scope of the invention.

1. A method of real-time video production collaboration, comprising:
accessing a project file comprising a first storyboard image associated with a first scene;
receiving a first live video feed from a first location;
associating the first live video feed with the first storyboard image;
transmitting, to a second location, an interface juxtaposing the first live video feed with the first storyboard image;
associating a first portion of the first live video feed with a first take of the first scene;
associating a second portion of the first live video feed with a second take of the first scene;
receiving, from one of the first location and the second location, an input related to one of the first and the second takes;
associating the input related to one of the first and the second takes with the project file;
generating an electronic report comprising the first storyboard image and information identifying the input related to one of the first and the second takes.

2. The method of claim 1, further comprising:
receiving a second live video feed from the first location, the second live video feed corresponding to a different shot than the first live video feed, wherein the first live video feed and the second live video feed are simultaneous;
associating the second live video feed with the first storyboard image;
transmitting, to the second location, an interface juxtaposing the second live video feed with the first storyboard image and the first live video feed;
associating a first portion of the second live video feed with the first take of the first scene;
associating a second portion of the second live video feed with a second take of the first scene;
receiving, from one of the first location and the second location, a selection of one of the first portion of the first live video feed, the second portion of the first live video feed, the first portion of the second live video feed, and the second portion of the second live video feed; and
wherein the electronic report further comprises information identifying the selection of one of the first portion of the first live video feed, the second portion of the first live video feed, the first portion of the second live video feed, and the second portion of the second live video feed.

3. The method of claim 1, wherein the input related to one of the first and the second takes is commentary regarding at least one of the first and second takes.

4. The method of claim 3, wherein the input related to one of the first and the second takes is an indication of a preferred take.

5. The method of claim 3, wherein the input related to one of the first and second takes is received during the capture of the live video feed associated with at least one of the first take and the second take.

6. The method of claim 1, further comprising:
providing a production interface, the production comprising at least one user-editable field associated with the first storyboard image and the first scene.

7. The method of claim 2, further comprising:
providing a production interface, the production interface comprising at least one user-editable field associated with the first storyboard image and the first scene.

8. The method of claim 1, further comprising extracting the first storyboard image from a storyboard file.

9. The method of claim 2, further comprising extracting the first storyboard image from a storyboard file.

10. The method of claim 6, further comprising extracting the first storyboard image from a storyboard file.

11. The method of claim 7, further comprising extracting the first storyboard image from a storyboard file.

12. The method of claim 11, wherein the input related to one of the first and the second takes is commentary regarding at least one of the first and second takes.

13. The method of claim 12, wherein the input related to one of the first and second takes is received during the capture of the live video feed associated with one of the first take and the second take.

14. The method of claim 1, wherein the first storyboard image is extracted from the storyboard file automatically by software.

15. The method of claim 2, wherein the first storyboard image is extracted from the storyboard file automatically by software.

16. The method of claim 13, wherein the first storyboard image is extracted from the storyboard file automatically by software.

17. A system for real-time video production collaboration comprising one or more computers and one or more storage devices storing one or more instructions that are operable, when executed by the one or more computers, to cause the one or more computers to perform one or more operations comprising:
accessing a project file comprising a first storyboard image associated with a first scene;
receiving a first live video feed from a first location;
associating the first live video feed with the first storyboard image;
transmitting, to a second location, an interface comprising a juxtaposition of the first live video feed with the first storyboard image;
associating a first portion of the first live video feed with a first take of the first scene;
associating a second portion of the first live video feed with a second take of the first scene;
receiving, from one of the first location and the second location, a selection of one of the first and the second takes;
associating the selection of one of the first and the second takes with the project file;
generating an electronic report comprising the first storyboard image and information identifying the selection of one of the first and the second takes.

18. The system of claim 17, wherein the one or more computers and one or more storage devices storing one or more instructions are operable, when executed by the one or more computers, to cause the one or more computers to perform one or more further operations comprising:
receiving a second live video feed from the first location, the second live video feed corresponding to a different shot than the first live video feed, wherein the first live video feed and the second live video feed are simultaneous;
associating the second live video feed with the first storyboard image;
transmitting, to the second location, an interface juxtaposing the second live video feed with the first storyboard image and the first live video feed;
associating a first portion of the second live video feed with the first take of the first scene;
associating a second portion of the second live video feed with a second take of the first scene;
receiving, from one of the first location and the second location, a selection of one of the first portion of the first live video feed, the second portion of the first live video feed, the first portion of the second live video feed, and the second portion of the second live video feed; and
wherein the electronic report further comprises information identifying the selection of one of the first portion of the first live video feed, the second portion of the first live video feed, the first portion of the second live video feed, and the second portion of the second live video feed.

19. A non-transitory computer-readable medium storing one or more instructions that when executed by a system of one or more computers causes the one or more computers to perform one or more operations comprising:
accessing a project file comprising a first storyboard image associated with a first scene;
receiving a first live video feed from a first location;
associating the first live video feed with the first storyboard image;
transmitting, to a second location, an interface comprising a juxtaposition of the first live video feed with the first storyboard image;
associating a first portion of the first live video feed with a first take of the first scene;
associating a second portion of the first live video feed with a second take of the first scene;
receiving, from one of the first location and the second location, a selection of one of the first and the second takes;
associating the selection of one of the first and the second takes with the project file;
generating an electronic report comprising the first storyboard image and information identifying the selection of one of the first and the second takes.

20. The computer-readable medium of claim 19, wherein the one or more instructions when executed by a system of one or more computers causes the one or more computers to perform one or more operations comprising:
receiving a second live video feed from the first location, the second live video feed corresponding to a different shot than the first live video feed, wherein the first live video feed and the second live video feed are simultaneous;
associating the second live video feed with the first storyboard image;
transmitting, to the second location, an interface juxtaposing the second live video feed with the first storyboard image and the first live video feed;
associating a first portion of the second live video feed with the first take of the first scene;
associating a second portion of the second live video feed with a second take of the first scene;
receiving, from one of the first location and the second location, a selection of one of the first portion of the first live video feed, the second portion of the first live video feed, the first portion of the second live video feed, and the second portion of the second live video feed; and
wherein the electronic report further comprises information identifying the selection of one of the first portion of the first live video feed, the second portion of the first live video feed, the first portion of the second live video feed, and the second portion of the second live video feed.
